(19) United States
(12) Patent Application Publication
(10) Pub. No.: US 2025/0057154 A1
(43) Pub. Date: Feb. 20, 2025

(54) WASP AND HORNET FORMULATIONS

(71) Applicant: S. C. Johnson & Son, Inc., Racine, WI (US)

(72) Inventors: Molly E. MCGUIRE, Racine, WI (US); Kevin J. MOE, Mount Pleasant, WI (US)

(21) Appl. No.: 18/778,231

(22) Filed: Jul. 19, 2024

Related U.S. Application Data
(60) Provisional application No. 63/533,288, filed on Aug. 17, 2023.

(51) Int. Cl. A01N 25/06; A01N 25/30; A01N 53/00; A01P 7/04

(52) U.S. Cl. CPC A01N 25/06; A01N 25/30; A01N 53/00; A01P 7/04

(57) ABSTRACT

Pest control compositions and related methods of use are disclosed having at least one active agent including cypermethrin, prallethrin, and mixtures thereof. The compositions may further include one or more of a solvent, a carrier, a corrosion inhibitor, and a surfactant. In some embodiments the pest control composition is non-foaming. In some embodiments, the pest control composition has an active agent, a petroleum distillate, at least one of ethyl alcohol, isopropyl alcohol, and acetone, a surfactant, and a corrosion inhibitor.

### CROSS REFERENCE TO RELATED APPLICATIONS

This application is related to, claims priority to, and incorporates herein by reference for all purposes U.S. Provisional Patent Application No. 63/533,288, filed Aug. 17, 2023.

### BACKGROUND

### 1. Technology Field

The present disclosure relates to a pest control composition, and more particularly, to a non-foaming pest control formulation for disabling wasps and hornets including cypermethrin, prallethrin, and mixtures thereof. The present disclosure also relates to a pest control composition including (i) cypermethrin and/or prallethrin, (ii) water, (iii) a solvent (e.g., petroleum distillates, ethyl alcohol, isopropyl alcohol, acetone, and mixtures thereof), (iv) propellant, and (v) corrosion inhibitor.

### 2. Description of the Background

Wasps, hornets, yellowjackets, and other stinging insects are a nuisance and a health hazard. According to the American College of Allergy, Asthma, and Immunology, potentially life-threatening allergic reactions occur in 0.4%-0.8% of children and 3% of adults, and at least 90-100 deaths per year result from insect sting anaphylaxis. These types of insects can build nests near human homes and businesses where humans can enter the nest defense zone frequently, increasing the encounter rate with the insects, thus increasing the possibility of insect stings. Wasps and hornets can alert the colony to attack when feeling threatened, even from a casual swat or merely a passerby. It is typically advised to stay at least 10 feet away from a nest to avoid encounters with the insects. Therefore, it is desirable to disable a nest by killing the insects within from a distance of at least 10 feet away.

Since the nests of these stinging insects are typically outdoors, using environmentally friendly ingredients in the pest control composition is desirable. Insecticide sprays used to target insect nests typically include a carrier to aid in the delivery of the active agent. For example, wasp and hornet insecticide formulations may include hydrocarbons and other fossil fuel-originating chemicals, such as acetonitrile, dichloromethane, hexane, octane, and xylene. However, it may be desirable to reduce or substitute these organic components. Furthermore, these chemicals can increase the cost of the formulation, especially since the carrier can, in some instances, be greater than 75% by weight of the total formulation.

Therefore, it is desirable to have pest control compositions, including a non-foaming pest control composition that includes sustainable, environmentally friendly solvent and carrier, and at the same time does not sacrifice the efficacy of the composition and the ability of the user to apply the composition to the nest from a safe distance.

### SUMMARY

In one aspect, a non-foaming pest control composition is provided. In this embodiment, the pest control composition includes an active agent, a petroleum distillate, at least one of ethyl alcohol, isopropyl alcohol, and acetone, a surfactant, and a corrosion inhibitor.

In further embodiments, the active agent is at least one of prallethrin, cypermethrin, and combinations thereof, the petroleum distillate is between about 2 wt. % and about 5 wt. %, the surfactant is between about 0.01 wt. % and about 0.1 wt. %. Further, the corrosion inhibitor is between about 0.05 wt. % and about 0.4 wt. % of at least one of ammonium benzoate, sodium benzoate, anhydrous disodium phosphate, potassium dihydrogen phosphate, sodium nitrite, and combinations thereof.

Further, the petroleum distillate is at least one of low odor paraffinic solvent, dearomatized kerosine, deodorized kerosene, and combinations thereof. In additional embodiments, the surfactant is at least one of lecithin, Quillaja saponin, polyglyceryl oleate, glyceryl monooleate, sorbitan monooleate, and any combinations thereof.

In further aspects, the active agent is between about 0.02 wt. % and about 0.2 wt. %. Even further, the at least one of ethyl alcohol, isopropyl alcohol, and acetone is between about 3 wt. % and about 15 wt. %. The non-foaming pest control composition may also include between 80 wt. % and 90 wt. % of water.

In other embodiments the non-foaming pest control composition may also include at least one propellant. Further, the at least one propellant may be between about 1 wt. % to about 5 wt. %. In some aspects of the present disclosure, the at least one propellant may be nitrogen, liquified petroleum gas, butane, n-butane, isobutane, pentane, propane, or any combinations thereof.

According to aspects of the present disclosure a non-foaming pest control composition may include an active agent, at least one of ethyl alcohol, isopropyl alcohol, and acetone, sorbitan monooleate, and sodium nitrite. Further, the active agent may be at least one of prallethrin, cypermethrin, and combinations thereof, the sorbitan monooleate may be between about 0.01 wt. % and about 0.5 wt. %, the corrosion inhibitor is between about 0.05 wt. % and about 0.4 wt. % of at least one of ammonium benzoate, sodium benzoate, anhydrous disodium phosphate, potassium dihydrogen phosphate, sodium nitrite, and combinations thereof, for example 0.26 wt. % of sodium nitrite.

According to other aspects of the present disclosure a non-foaming pest control composition may include an active agent, at least one of ethyl alcohol, isopropyl alcohol, and acetone, sorbitan monooleate, and sodium nitrite. Further, the active agent may be at least one of prallethrin, cypermethrin, and combinations thereof, the at least one of ethyl alcohol, isopropyl alcohol, and acetone is ethyl alcohol, the sorbitan monooleate may be between about 0.01 wt. % and about 0.5 wt. %, the corrosion inhibitor is between about 0.05 wt. % and about 0.4 wt. % of either sodium nitrite or a combination of anhydrous disodium phosphate and potassium dihydrogen phosphate, for example about 0.26 wt. % of sodium nitrite. In further embodiments, the active agent is between about 0.01 wt. % and about 0.2 wt. %, or between about 0.01 wt. % and about 0.1 wt. %.

In other embodiments the non-foaming pest control composition may also include at least one propellant. Further, the at least one propellant may be between about 2 wt. % to about 4 wt. %. In some aspects of the present disclosure, the at least one propellant may be nitrogen, liquified petroleum gas, butane, n-butane, isobutane, pentane, propane, or any combinations thereof. The non-foaming pest control composition may also include between 80 wt. % and 90 wt. % of water.

Other aspects of the present disclosure provide a method of killing wasps or hornets. The method may include applying to the wasp or hornet a composition that includes an insecticide active agent, a petroleum distillate, a surfactant, a corrosion inhibitor, and at least one of ethyl alcohol, isopropyl alcohol, and acetone. The composition may include the insecticide active agent between about 0.02 wt. % and about 0.07 wt. %, the petroleum distillate between about 2 wt. % and about 5 wt. %, the surfactant between about 0.01 wt. % and about 0.1 wt. % and of any one of polyglyceryl oleate, glyceryl monooleate, sorbitan monooleate, and any combinations thereof. The composition may further include the corrosion inhibitor between about 0.05 wt. % and about 0.26 wt. % of sodium nitrite.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the disclosure.

FIG. 1 shows a plot of the knockdown time of yellow jackets, paper wasps, and bald-faced hornets when treated with the non-foaming insecticide composition according to an aspect as disclosed herein.

### DETAILED DESCRIPTION

The term “about” or “approximately” means within an acceptable error range for the particular value as determined by one of ordinary skill in the art, which will depend in part on how the value is measured or determined, i.e., the limitations of the measurement system, i.e., the degree of precision required for a particular purpose, such as a pharmaceutical formulation. The term “about” refers to variation in the numerical quantity that may occur, for example, through typical measuring and liquid handling procedures used for making concentrates or solutions in the real world; through inadvertent error in these procedures; through differences in the manufacture, source, or purity of the ingredients used to make the compositions or carry out the methods; and the like. The term “about” may also encompass amounts that differ due to different equilibrium conditions for a composition resulting from a particular initial mixture. Where any range or value is disclosed as “about” or “approximately” it should be understood that the stated value itself is also expressly contemplated.

In one embodiment, the term “about” refers to a range of values +/−5% of a specified value. For example, “about” can mean within 1 or more than 1 standard deviations, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value. Where particular values are described in the application and claims, unless otherwise stated the term “about” meaning within an acceptable error range for the particular value should be assumed.

The term “substantially,” as used herein, means at least about 80%, preferably at least about 90%, more preferably at least about 99%, for example at least about 99.9%. In some embodiments, the term “substantially” can mean completely, or about 100%.

The term “weight percent”, “wt. %”, “wt. %,” “percent by weight”, “% by weight”, and variations thereof, as used herein, refer to the concentration of a substance as the weight of that substance divided by the total weight of the composition and multiplied by 100. It is understood that, as used here, “percent”, “%”, and the like may be synonymous with “weight percent”, “wt. %”, etc.

As used herein, “pests” can mean any organism whose existence it can be desirable to control. Pests can include, for example, bacteria, cestodes, fungi, insects, nematodes, parasites, plants, and the like. In addition, as used herein, “pesticidal” can mean, for example, antibacterial, antifungal, antiparasitic, herbicidal, insecticidal, and the like.

More so, for purposes of simplicity, the term “insect” is used in this application. However, it should be understood that the term “insect” refers, not only to insects, but may also to mites, spiders, and other arachnids, larvae, and like invertebrates. As used herein, the term “insect” refers to and includes but is not limited to insects or arachnids capable of acting as vectors for disease to humans, animals, birds, fish, plants or plant parts, or capable of irritating or causing economic damage thereto. Examples include but are not limited to nematodes, biting insects (such as mosquitoes, gnats, horse flies, ticks, tsetse flies, blowfly, screw fly, bed bugs, fleas, lice and sea lice), sap-sucking insects (such as aphids and thrips) and further include arachnids, ticks, termites, silverfish, ants, cockroaches, locust, fruit flies, wasps, hornets, yellow jackets, scorpions, chiggers and mites (such as dust mites).

Further, for purposes of this application, the term “pest control” shall refer to having a repellent effect, a pesticidal effect, or both. “Repellent effect” is an effect wherein more insects are repelled away from a host or area that has been treated with the composition than a control host or area that has not been treated with the composition. Similarly, the term “repellency” or “repelling” or “repel” refers to the ability of the compositions described herein to cause a pest or insect to deviate away from or avoid a surface, object or insect breeding site treated with said composition. In some embodiments, as will be shown in the present disclosure, a repellent effect is an effect wherein at least about 75% of insects are repelled away from a host or area that has been treated with the composition. In some embodiments, however, a repellent effect is an effect wherein at least about 90% of insects are repelled away from a host or area that has been treated with the composition. In addition, “pesticidal effect” or “insecticidal effect” is an effect wherein treatment with a composition causes at least about 1% of the insects to die. In this regard, an LC1 to LC100 (lethal concentration) or an LD1 to LD100 (lethal dose) of a composition will cause a pesticidal effect. In some embodiments, the pesticidal effect or the insecticidal effect is an effect wherein treatment with a composition causes at least about 5% of the exposed insects to die. In some embodiments, the target pest is a non-insect, such as a parasite.

As used herein, the term “killing” or “kill” refers to the ability of at least one active in a non-foaming composition to render an insect dead. As further used herein, the term “knocking down” or “knockdown” refers to the ability of the composition described herein to render an insect immobile for a pre-determined period of time. For example, a flying insect contacted with a composition described herein is said to be “knocked-down” if it falls to ground and is unable to fly, even though it may be able to move body parts so it cannot be categorized as completely paralyzed. The insect's ability to move, feed, reproduce, spread disease, or irritate is severely curtailed during the period in which it is knocked down.

It is known in the pest control field that consumers desire a product that has a reduced environmental impact. Therefore, it is important to develop a pest control composition that has sustainable components and does not compromise the insect killing efficacies. In an embodiment, the composition optionally comprises a fragrance. It has been found that a non-foaming pest control composition according to an embodiment of the present disclosure comprising at least one insecticide active agent, a petroleum distillate, at least one of ethyl alcohol, isopropyl alcohol, and acetone, a surfactant, a corrosion inhibitor, and optionally a fragrance provides such benefits.

The compositions described herein present novel combinations of active agents and/or other components that result in an improved pest control composition offering consumers a sustainable, low-environmental impact composition without sacrificing efficacy. The sustainable composition allows the user to spray the pests outside and have confidence the composition has a low impact on the environment when compared to some other pest control products. In the present disclosure, Applicant demonstrates that the water-based non-foaming composition is highly efficacious in killing insects.

In an embodiment, one active ingredient is fast acting and provides “knock down” of the insects so they cannot move after exposure. Another active ingredient ultimately kills the insect, ensuring after the insects are “knocked down.” In particular, the pest control composition described herein causes pest mortality in wasps, hornets, and yellowjackets by paralyzing and then killing the insect, resulting in a pest knockdown rate as much as 100% in 30 seconds, and a pest mortality rate as much as 100% in 24 hours.

Active agent. The active agent imparts insecticidal and/or insect repellent properties to the non-foaming pest composition. In some embodiments, the active agent of the non-foaming pest control compositions of the present disclosure can include one or more pyrethrins, pyrethroids, and combinations thereof. In specific embodiments, the active agent of the non-foaming pest control composition includes one or more of prallethrin, cypermethrin, and combinations thereof. In some embodiments, the active of the non-foaming pest control composition includes prallethrin. In other embodiments, the active of the non-foaming pest control composition includes cypermethrin. In other embodiments, the active of the non-foaming pest control composition includes cypermethrin and prallethrin. In some embodiments, the active ingredient can be included in the composition in at least about 0.005 wt. % or at least about 0.01 wt. % and up to about 0.02 wt. %, up to about 0.03 wt. %, up to about 0.04 wt. %, up to about 0.05 wt. %, up to about 0.06 wt. %, up to about 0.07 wt. %, up to about 0.08 wt. %, up to about 0.09 wt. %, up to about 0.1 wt. %, up to about 0.15 wt. %, or up to about 0.2 wt. %. In some embodiments, the active ingredient can be included in the composition in at least about 0.02 wt. % and up to about 0.03 wt. %, up to about 0.04 wt. %, up to about 0.05 wt. %, up to about 0.06 wt. %, up to about 0.07 wt. %, up to about 0.08 wt. %, up to about 0.09 wt. %, up to about 0.1 wt. %, up to about 0.15 wt. %, or up to about 0.2 wt. %.

Prallethrin (CAS No. 23031-36-9) is a member of the pyrethroid class of insecticides and has the IUPAC name 2-methyl-4-oxo-3-prop-2-yn-1-ylcyclopent-2-en-1-yl-2,2-dimethyl-3-(2-methylprop-1-en-1-yl)cyclopropanecarboxylate. Prallethrin can be included in the composition in at least about 0.005 wt. % or at least about 0.01 wt. % and up to about 0.02 wt. %, up to about 0.03 wt. %, up to about 0.04 wt. %, up to about 0.05 wt. %, up to about 0.06 wt. %, up to about 0.07 wt. %, up to about 0.08 wt. %, up to about 0.09 wt. %, up to about 0.1 wt. %, up to about 0.15 wt. %, or up to about 0.2 wt. %. Prallethrin can also be included in the composition in at least about 0.02 wt. % and up to about 0.03 wt. %, up to about 0.04 wt. %, up to about 0.05 wt. %, up to about 0.06 wt. %, up to about 0.07 wt. %, up to about 0.08 wt. %, up to about 0.09 wt. %, up to about 0.1 wt. %, up to about 0.15 wt. %, or up to about 0.2 wt. %.

Cypermethrin (CAS No. 52315-07-8) is a synthetic pyrethroid that behaves as a fast-acting neurotoxin in insects. Cypermethrin has the IUPAC name [cyano-(3-phenoxyphenyl)methyl]3-(2,2-dichloroethenyl)-2,2-dimethylcyclopropane-1-carboxylate. Cypermethrin can be included in the composition in at least about 0.005 wt. % or at least about 0.01 wt. % and up to about 0.02 wt. %, up to about 0.03 wt. %, up to about 0.04 wt. %, up to about 0.05 wt. %, up to about 0.06 wt. %, up to about 0.07 wt. %, up to about 0.08 wt. %, up to about 0.09 wt. %, up to about 0.1 wt. %, up to about 0.15 wt. %, or up to about 0.2 wt. %. Cypermethrin can also be included in the composition in at least about 0.02 wt. % and up to about 0.03 wt. %, up to about 0.04 wt. %, up to about 0.05 wt. %, up to about 0.06 wt. %, up to about 0.07 wt. %, up to about 0.08 wt. %, up to about 0.09 wt. %, up to about 0.1 wt. %, up to about 0.15 wt. %, or up to about 0.2 wt. %.

Solvent. The composition of the present disclosure may also include a solvent, for example to dissolve certain components, to enhance functionality of the components, or for textural and sensorial attributes. In some embodiments, the solvent includes at least one of ethyl alcohol, isopropyl alcohol, acetone, hydrotreated light petroleum distillates, and combinations thereof.

In certain embodiments, the composition includes a solvent. In these embodiments, the solvent may include at least one of ethyl alcohol, isopropyl alcohol, acetone, hydrotreated light petroleum distillates, and combinations thereof. In some embodiments, the composition includes about 1 wt. % to about 20 wt. % of the solvent, and in some other embodiments, the composition includes about 1 wt. % to about 18 wt. % of the solvent, based on the total weight of the composition. In further embodiments, the composition includes about 5 wt. % to about 15 wt. % based on the total weight of the composition. In other embodiments, the composition includes a solvent present in about 8 wt. % to about 12 wt. %, based on the total weight of the composition, or between about 9 wt. % to about 11 wt. %, based on the total weight of the composition. In yet another embodiment, the solvent is present between about 10 wt. % to about 11 wt. %, based on the total weight of the composition. While specific values chosen for this embodiment are recited, it is to be understood that, within the scope of the disclosure, the concentration of solvent may vary to suit different applications. The concentration ranges of solvent will vary based on the additional components of the pest control composition, including, but not limited to, the cypermethrin, prallethrin, surfactant, and carrier.

Additionally, according to one embodiment, the solvent includes at least one of ethyl alcohol, isopropyl alcohol, acetone, hydrotreated light petroleum distillates, and/or combinations thereof. For example, in an embodiment, the solvent includes at least one of ethyl alcohol, hydrotreated light petroleum distillates, and/or combinations thereof. In another embodiment, the solvent includes at least one of ethyl alcohol, isopropyl alcohol, acetone, and/or combinations thereof, and combinations thereof. In an even further embodiment, the solvent is selected from the group consisting of ethyl alcohol, isopropyl alcohol, acetone, hydrotreated light petroleum distillates, and combinations thereof.

Further, in an embodiment, the solvent includes ethyl alcohol. In this embodiment, the composition includes about 3 wt. % to about 15 wt. %, based on the total weight of the composition. In further embodiments, the composition includes about 6 wt. % to about 7 wt. %, based on the total weight of the composition. In even further embodiments, the composition includes about 6.1 wt. % to about 6.5 wt. %, based on the total weight of the composition. In other embodiments, however, the composition is substantially free of ethyl alcohol. While specific values chosen for this embodiment are recited, it is to be understood that, within the scope of the disclosure, the concentration of ethyl alcohol may vary to suit different applications. The concentration ranges of ethyl alcohol, for example, will vary based on the additional components of the pest control composition, such as the active agents and the carrier.

In yet another embodiment, the solvent includes isopropyl alcohol. In this embodiment, the composition includes about 3 wt. % to about 15 wt. % isopropyl alcohol, based on the total weight of the composition. In further embodiments, the composition includes about 6 wt. % to about 7 wt. % isopropyl alcohol, based on the total weight of the composition. In even further embodiments, the composition includes about 6.1 wt. % to about 6.5 wt. % isopropyl alcohol, based on the total weight of the composition. In other embodiments, however, the composition is substantially free of isopropyl alcohol. While specific values chosen for this embodiment are recited, it is to be understood that, within the scope of the disclosure, the concentration of isopropyl alcohol may vary to suit different applications. The concentration ranges of isopropyl alcohol, for example, will vary based on the additional components of the pest control composition, such as the active agents, and the carrier.

Still further, in an embodiment, the solvent includes acetone. In this embodiment, the composition includes about 3 wt. % to about 15 wt. % acetone, based on the total weight of the composition. In further embodiments, the composition includes about 6 wt. % to about 7 wt. % acetone, based on the total weight of the composition. In even further embodiments, the composition includes about 6.1 wt. % to about 6.5 wt. % acetone, based on the total weight of the composition. In other embodiments, however, the composition is substantially free of acetone. While specific values chosen for this embodiment are recited, it is to be understood that, within the scope of the disclosure, the concentration of acetone may vary to suit different applications. The concentration ranges of acetone, for example, will vary based on the additional components of the pest control composition, such as the active agents, and the carrier.

In an embodiment, the solvent can include hydrotreated light petroleum distillates. Hydrotreated light petroleum distillates include low odor paraffinic solvent, dearomatized kerosine, deodorized kerosene, CAS No. 64742-47-8, and combinations thereof. In this embodiment, the composition includes about 2 wt. % to about 5 wt. % hydrotreated light petroleum distillates, based on the total weight of the composition. In further embodiments, the composition includes about 3.5 wt. % to about 4.5 wt. % hydrotreated light petroleum distillates, based on the total weight of the composition. In even further embodiments, the composition includes about 3.9 wt. % to about 4.1 wt. % hydrotreated light petroleum distillates, based on the total weight of the composition. While specific values chosen for this embodiment are recited, it is to be understood that, within the scope of the disclosure, the concentration of hydrotreated light petroleum distillates may vary to suit different applications. The concentration ranges of hydrotreated light petroleum distillates, for example, will vary based on the additional components of the non-foaming pest control composition, such as the active agents, solvent, corrosion inhibitor, and surfactant.

Carrier. In certain embodiments, the composition includes a carrier, for example, to help aid in the delivery of the active agents, diluent, and flow aid. The carrier may improve content uniformity and facilitates reproducibility of the applied dose. The carrier, among other ingredients, allows the pesticide to be dispersed effectively. The term “carrier” as used herein means a material, which can be inorganic or organic and of synthetic or natural origin, with which the active agent is mixed or formulated to facilitate its application to the host, area, or other object to be treated, or to facilitate its storage, transport, and/or handling. In general, any of the materials customarily employed in formulating repellents, pesticides, herbicides, or fungicides, are suitable.

In certain embodiments, the carrier includes about 80 wt. % to about 90 wt. % carrier, based on the total weight of the composition. In certain embodiments, the carrier includes about 82 wt. % to about 89 wt. % carrier, based on the total weight of the composition. In other embodiments, the carrier includes about 84 wt. % to about 88 wt. % carrier, based on the total weight of the composition. In still further embodiments, the carrier includes about 85 wt. % to about 87 wt. % carrier, based on the total weight of the composition. In still further embodiments, the carrier includes about 86 wt. % carrier, based on the total weight of the composition. In some embodiments, the carrier includes water. In other embodiments, the carrier is water. While specific values chosen for this embodiment are recited, it is to be understood that, within the scope of the disclosure, the amount of carrier may vary to suit different applications. The amount ranges of carrier will vary based on the additional components of the non-foaming pest control composition, such as the active agents, solvent, corrosion inhibitor, and surfactant.

Surfactant. The formulation may include a surfactant, for example, to lower the surface tension of the composition. In some embodiments, the composition includes a surfactant. The surfactant can be a non-ionic surfactant with an HLB (Hydrophile-Lipophile Balance) value less than 9 but preferably between 3 and 8 and most preferably between 4 and 6. In some embodiments, the surfactant includes at least one of lecithin, Quillaja saponin, polyglyceryl oleate, glyceryl monooleate, sorbitan monooleate, and any combinations thereof.

In certain embodiments, the surfactant is present in about 0.01 wt. % to about 5 wt. %, based on the total weight of the composition. In an embodiment, the surfactant is present from about 0.01 wt. % to about 4 wt. %, based on the total weight of the composition. In other embodiments, the composition includes about 0.01 wt. % to about 3 wt. % surfactant, based on the total weight of the composition. In some embodiments, the composition includes about 0.01 wt. % to about 2 wt. % surfactant, based on the total weight of the composition. In certain embodiments, the composition includes about 0.01 wt. % to about 1 wt. % surfactant, based on the total weight of the composition. In an embodiment, the surfactant is present from about 0.01 wt. % to about 0.5 wt. %, based on the total weight of the composition. In an embodiment, the surfactant is present from about 0.01 wt. % to about 0.1 wt. %, based on the total weight of the composition. In even further embodiments, however, the composition is substantially free of a surfactant. While specific values chosen for this embodiment are recited, it is to be understood that, within the scope of the disclosure, the concentration of surfactant may vary to suit different applications. The concentration ranges of surfactant will vary based on the additional components of the non-foaming pest control composition, including, but not limited to, the solvent, the carrier, corrosion inhibitor, propellant, and the active agents.

Corrosion inhibitor. In certain embodiments, the composition includes a corrosion inhibitor, for example, to help prevent degradation of a metal container that is used to store and/or dispense the composition. The pest control formulation as disclosed herein can be provided to the user in a metal container. Preventing the corrosion of the container is important to avoid spilling and wasting the contents if the container is stored for an extended period of time between uses. Therefore, a corrosion inhibitor can be added to the formulation to increase shelf life. Corrosion inhibitors can include inorganic compounds as well as aliphatic, aromatic amines, nitrogen heterocyclic compounds, and phosphates. In some embodiments, the corrosion inhibitor can be ammonium benzoate, sodium benzoate, anhydrous disodium phosphate, potassium dihydrogen phosphate, or any combination thereof. In other embodiments, the corrosion inhibitor can be a combination of anhydrous disodium phosphate and potassium dihydrogen phosphate. In specific embodiments herein, the inorganic salt sodium nitrite is used as a corrosion inhibitor. Sodium nitrite is an anodic inhibitor and is ideal for a closed system such as a pressurized aerosol can, as nitrite converts to nitrate when exposed to oxygen. In certain embodiments, the corrosion inhibitor is included at about 0.05 wt. % to about 0.4 wt. %, based on the total weight of the composition. In some embodiments, sodium nitrite is included at about 0.05 wt. % to about 0.26 wt. %, based on the total weight of the composition. In some embodiments, sodium nitrite is included at about 0.1 wt. % to about 0.2 wt. %, based on the total weight of the composition. In a particular embodiment, sodium nitrite can be included at about 0.12 wt. % to about 0.15 wt. %, based on the total weight of the composition. In a particular embodiment, sodium nitrite can be included at about 0.129 wt. %, based on the total weight of the composition. In other embodiments, anhydrous disodium, phosphate potassium dihydrogen phosphate, or combinations thereof can be used as the corrosion inhibitor. In a particular embodiment, anhydrous disodium phosphate can be included at about 0.323 wt. %, and anhydrous disodium phosphate can be included at about 0.323 wt. %, based on the total weight of the composition. In alternative embodiments, these corrosion inhibitors may be included in a weight percentage between about 0.1 wt. % and about 1 wt. %, or between about 0.1 wt. % and about 0.5 wt. %, or between about 0.3 wt. % and about 0.4 wt. %. While specific values chosen for this embodiment are recited, it is to be understood that, within the scope of the disclosure, the concentration of corrosion inhibitor may vary to suit different applications. The concentration ranges of corrosion inhibitor will vary based on the additional components of the non-foaming pest control composition, including, but not limited to, the solvent, the carrier, surfactant, propellant, and the active agents.

Propellant. In certain embodiments, the composition includes a propellant, for example, to provide a force to expel the formulation from the container. In certain embodiments, the propellant is selected from the group comprising methane, ethane, propane, pentane, isobutene, butane, n-butane, isobutane, dimethyl ether, 1,1-difluoroethane, 1,1,1,2-tetrafluoroethane, carbon dioxide, nitrogen, air, liquified petroleum gas, and any combinations thereof. In certain embodiments, the propellant is selected from the group consisting of methane, ethane, propane, pentane, isobutene, butane, n-butane, isobutane, dimethyl ether, 1,1-difluoroethane, 1,1,1,2-tetrafluoroethane, carbon dioxide, nitrogen, air, and any combinations thereof. In some embodiments, the propellant can be pressurized to about 50 psi, about 60 psi, about 70 psi, about 80 psi, about 90 psi, or about 100 psi in the can. In certain embodiments, the composition includes about 1 wt. % to about 5 wt. % of the propellant, based on the total weight of the composition. In certain embodiments, the composition includes about 1.5 wt. % to about 4.5 wt. % of the propellant, based on the total weight of the composition. In certain embodiments, the composition includes about 2 wt. % to about 4 wt. % of the propellant, based on the total weight of the composition. In certain embodiments, the composition includes about 3.0 wt. % to about 4.0 wt. % of the propellant, based on the total weight of the composition. In certain embodiments, the composition includes about 3.4 wt. % to about 3.6 wt. % of the propellant, based on the total weight of the composition. While specific values chosen for this embodiment are recited, it is to be understood that, within the scope of the disclosure, the concentration of propellant may vary to suit different applications. The concentration ranges of propellant will vary based on the additional components of the non-foaming pest control composition, including, but not limited to, the solvent, the carrier, surfactant, corrosion inhibitor, and the active agents.

Fragrance. In certain embodiments, the composition includes a fragrance, for example to provide a pleasing experience for the user. In certain embodiments, the fragrance is selected from the group comprising commercially available fragrances, natural fragrances, synthetic fragrances, and any combinations thereof. In certain embodiments, the composition includes about 0.01 wt. % to 8 wt. %, or about 0.1 wt. % to about 6 wt. %, or about 0.5 wt. % to about 6 wt. %, or about 0.6 wt. % to about 6 wt. %, or about 0.6 wt. %, or about 6 wt. % of a fragrance.

Embodiments of the present disclosure also include a method of killing insects comprising applying to a region in need thereof a composition comprising at least one active agent (e.g., cypermethrin, prallethrin, and combinations thereof), from about 80 wt. % to about 90 wt. % carrier (e.g., water), a solvent (e.g., ethyl alcohol, isopropyl alcohol, acetone, hydrotreated light petroleum distillates, and combinations thereof), a surfactant (e.g., sorbitan monooleate), a propellant (e.g. pressurized propane, butane, and combinations thereof) and a corrosion inhibitor (e.g., sodium nitrite). The method can include applying the composition to a nest of stinging insects as a jet spray from a pressurized container, wherein the jet spray is a forceful stream emanating from the pressurized container. The jet spray allows the composition to be aimed accurately at the nest or a nest opening and applied from a substantial distance from the nest (e.g., at least 10 feet away).

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### EXAMPLES

The following Examples are provided to demonstrate and further illustrate certain embodiments and aspects of the present disclosure and are not to be construed as limiting the scope of the disclosure.

### Example 1. Evaluation of Direct Spray Efficacy of Water Based Aerosol Against Paper Wasps, Yellow Jackets, and Bald-Faced Hornets

According to an aspect of the disclosure, the composition can include a propellent, a first solvent comprising petroleum distillates, a second solvent comprising at least one of ethyl alcohol, isopropyl alcohol, or acetone, active agents, a surfactant, a carrier, and a corrosion inhibitor. Three exemplary formulas (i.e., Formulation 1, Formulation 2, and Formulation 3) are shown in Table 1. All concentrations are in wt. %, based on the total weight of the composition.

TABLE 1
Exemplary formulations.

| | Formulation | Formulation | Formulation |
|---|---|---|---|
| Ingredient | 1 | 2 | 3 |
| Hydrocarbon Propellant | 3.5 | 3.5 | 3.5 |
| Distillates (Petroleum) | 4 | 4 | 4 |
| Hydrotreated Light | | | |
| Ethyl Alcohol | 6.25 | — | — |
| Isopropyl Alcohol | — | 6.25 | — |
| Acetone | — | — | 6.25 |
| CYPERMETHRIN | 0.052 | 0.052 | 0.052 |
| TECHNICAL 96.7% | | | |
| Prallethrin 93% | 0.021 | 0.021 | 0.021 |
| Sorbitan Monooleate | 0.05 | 0.05 | 0.05 |
| Water | 86 | 86 | 86 |
| Sodium Nitrite | 0.1292 | 0.1292 | 0.1292 |

Test systems were sprayed with a test substance (Formulation 1) for approximately 1-second dosages. Knockdown observations were recorded, and test systems were held for mortality counts. Confirmation of kill was confirmed within 24 hours of treatment.

### Method

### Test Design: Treatment and Untreated Controls

Three species were tested: 35 treatment replicates were conducted per species; 105 treatment replicates in total. 35 control replicates were set up per species; 105 control replicates in total.

One species was tested per day and one insect was used per replicate. Test substance was sprayed for an approximate 1-second dose from 18″ and the dispensed test substance weight (g) was recorded for each replicate. Knockdown and 24-hour mortality observations were recorded.

### Test Procedure/Knockdown Observations:

A treatment container with one insect was placed into the spray tower apparatus. The test substance was shaken before each use. For the first use of each unit of test substance, the can was sprayed into the fume hood (but away from test subjects) to clear the dip tube and the weight of this test spray was recorded. The test substance was then placed at a mark measured 18-inches from the treatment ring and dispensed directly at each insect for approximately 1-second. Time of test system knockdown was recorded. (Knockdown is defined as a state in which a pest is rendered incapable of coordinated movement or unable to right itself following exposure to a pesticide (e.g., on its back with only a single appendage twitching) or similar involuntary movements of a moribund test system.) Following each treatment replicate, the test substance was re-weighed, and the dispensed weight was recorded.

### Mortality Counts

Mortality counts were taken at 24±4 hours post treatment and ceased thereafter because all treated replicates were observed to be dead.

### Observation Counts Consisted of Three Classifications:

Alive: defined as test systems experiencing no affects from the treatment.
Dead: defined as test systems that do not move even after prodding.
Moribund: defined as test systems experiencing some aberrant behavior such as: on their back or side, unable to maintain a normal posture and/or leg twitching or similar involuntary movements of a test system experiencing affects from the treatment. Moribund insects are not considered part of mortality in final calculations.

### Calculations and Data Analysis

Mean percent knockdown and percent knocked down in 10-seconds or less was determined for test systems treated with the test substance. Percent mortality was determined at 24 hours for the untreated control and treated test systems as all treated test systems.

### Results

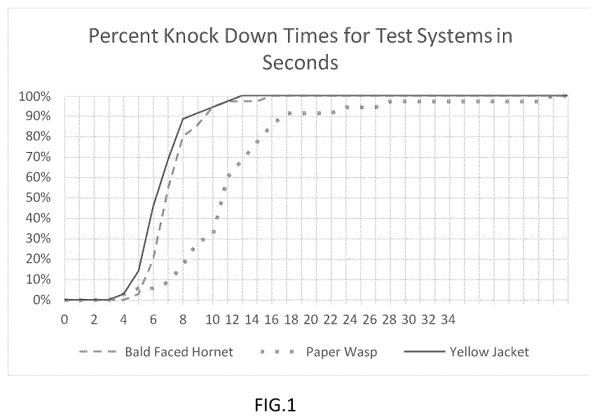

100% Mortality was observed at 24 hours for all species. Percent knockdown in Control test systems of paper wasps and bald-faced hornets had zero mortality at the 24-hour observation period; yellow jackets controls exhibited 6% mortality at the 24-hour observation period. An overlay plot of the percent knockdown vs time (sec) for the three species is shown in FIG. 1. Replicate data of knockdown times in seconds are shown in Table 2.

TABLE 2
Replicate Knockdown Times (in seconds) for Three Species

| | | Bald- | |
|---|---|---|---|
| | Paper | Faced | Yellow |
| Replicate | Wasp | Hornet | Jacket |
| 1 | 14.36 | 7.80 | 5.42 |
| 2 | 8.32 | 9.99 | 7.34 |
| 3 | 32.83 | 8.84 | 6.96 |
| 4 | 10.65 | 6.24 | 7.19 |
| 5 | 13.80 | 7.67 | 5.02 |
| 6 | 7.58 | 7.08 | 7.06 |
| 7 | 10.77 | 6.55 | 4.99 |
| 8 | 10.96 | 5.71 | 5.09 |
| 9 | 7.12 | 4.58 | 5.00 |
| 10 | 10.02 | 6.43 | 10.09 |
| 11 | 10.70 | 7.74 | 5.92 |
| 12 | 7.11 | 6.46 | 3.93 |
| 13 | 13.49 | 7.13 | 4.09 |
| 14 | 9.68 | 6.61 | 4.19 |
| 15 | 3.41 | 8.00 | 6.02 |
| 16 | 11.61 | 7.21 | 5.41 |
| 17 | 14.42 | 9.78 | 6.12 |
| 18 | 10.83 | 6.18 | 7.59 |
| 19 | 10.99 | 13.33 | 5.85 |
| 20 | 4.96 | 5.30 | 6.35 |
| 21 | 10.38 | 8.21 | 5.06 |
| 22 | 6.96 | 9.46 | 11.18 |
| 23 | 8.95 | 5.20 | 8.12 |
| 24 | 12.86 | 6.55 | 5.19 |
| 25 | 13.24 | 5.99 | 9.34 |
| 26 | 10.34 | 6.65 | 5.15 |
| 27 | 21.11 | 6.31 | 8.62 |
| 28 | 8.81 | 5.69 | 6.66 |
| 29 | 18.71 | 6.29 | 5.03 |
| 30 | 8.74 | 10.02 | 6.06 |
| 31 | 12.65 | 6.21 | 7.75 |
| 32 | 11.24 | 5.40 | 5.56 |
| 33 | 10.59 | 7.17 | 7.22 |
| 34 | 11.12 | 7.32 | 5.72 |
| 35 | 12.52 | 6.39 | 6.75 |
| MEAN | 11.48 | 7.19 | 6.37 |

Table 3 summarizes mean time to knock down and percent of replicates that were knocked down in 10 seconds or less. The paper wasp knock down time was slightly longer, with a mean time to KD of just over 11 seconds.

TABLE 3
Knockdown (KD) and Mortality

| | | | Percent | Percent |
|---|---|---|---|---|
| Species - Test | Mean time to | % KD ≤ 10 | treatment | control |
| Systems | KD | seconds | mortality | mortality |
| Yellow jackets | 6.37 seconds | 94% | 100% | 6% |
| Bald-faced hornet | 7.19 seconds | 94% | 100% | 0% |
| Paper wasps | 11.48 seconds | 31% | 100% | 0% |

### Conclusions

This study confirms rapid knockdown and demonstrates spray kill efficacy of RWH-WB against wasps and hornets as demonstrated on paper wasps, yellow jackets, and bald-faced hornets under laboratory conditions. Mean knockdown times were 11.48 seconds for paper wasps, 6.37 seconds for yellow jackets, and 7.19 seconds for bald-faced hornets, and 100% mortality was observed at the 24-hour observation period for all three species tested.

As shown in the efficacy data in Table 2 and Table 3, the test results of the present example show there is fast knockdown time (between 6 and 12 sec) and high mortality (100% in all cases) for all three species tested. The data for this case show the excellent efficacy of the formulations of the present disclosure in knockdown and mortality while the sustainability of the composition is improved through the use of water as a carrier.

The non-foaming pest control composition is a wasp and hornet killing formula dispensed as a jet spray allowing users to treat wasp and hornet nests from a safe distance. It utilizes a water-based formulation containing two active ingredients. One active ingredient is fast acting and provides “knock down” on the insects so they cannot move after being exposed. The other active ingredient provides quick killing ensuring after the insects are “knocked down” and paralyzed that they are killed. Inside the container there is a high-pressure propellant that helps enable the formula to be pushed out of the container with enough force to be delivered to the nest with accuracy from a safe distance. Continuously applying the composition to the nest opening kills any insect trying to exit, thereby clogging the nest exit and thus preventing any insects from exiting, further reducing any chance of encounters with aggressing insects. The combination of the active agents, carrier, and propellant provide a water-based wasp and hornet product which allows for treatment of nests, without having to approach or directly interact with the nest during treatment, while using efficient and sustainable materials.

The various methods and techniques described above provide a number of ways to carry out embodiments of the present disclosure. Of course, it is to be understood that not necessarily all objectives or advantages described may be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as may be taught or suggested herein. A variety of advantageous and disadvantageous alternatives are mentioned herein. It is to be understood that some preferred embodiments specifically include one, another, or several advantageous features, while others specifically exclude one, another, or several disadvantageous features, while still others specifically mitigate a present disadvantageous feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be mixed and matched by one of ordinary skill in this art to perform methods in accordance with principles described herein. Among the various elements, features, and steps some will be specifically included and others specifically excluded in diverse embodiments.

Although the invention has been disclosed in the context of certain embodiments and examples, it will be understood by those skilled in the art that the embodiments of the invention extend beyond the specifically disclosed embodiments to other alternative embodiments and/or uses and modifications and equivalents thereof.

Many variations and alternative elements have been disclosed in embodiments of the present invention. Still further variations and alternate elements will be apparent to one of skill in the art. Among these variations, without limitation, are the at least two active ingredients selected for the pest control composition, the target pest, and the amounts of the various ingredients present in the pest control composition. Various embodiments of the invention can specifically include or exclude any of these variations or elements.

In some embodiments, the numbers expressing quantities of ingredients, properties such as weight percentages, percent repellency, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

In some embodiments, the terms “a” and “an” and “the” and similar references used in the context of describing a particular embodiment of the present disclosure (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Particular embodiments of the present disclosure are described herein, including the best mode known to the inventors for carrying out the invention. Variations on those preferred embodiments will become apparent to those of ordinary skill in the art upon reading the foregoing description. It is contemplated that skilled artisans can employ such variations as appropriate, and the invention can be practiced otherwise than specifically described herein. Accordingly, many embodiments of this invention include all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications throughout this specification. Each of the above cited references and printed publications are herein individually incorporated by reference in their entirety.

It is to be understood that the embodiments of the invention disclosed herein are illustrative of the principles of the present invention. Other modifications that can be employed can be within the scope of the invention. Thus, by way of example, but not of limitation, alternative configurations of the present invention can be utilized in accordance with the teachings herein. Accordingly, embodiments of the present invention are not limited to that precisely as shown and described.

1. A non-foaming pest control composition, comprising:
an active agent;
a petroleum distillate;
at least one of ethyl alcohol, isopropyl alcohol, and acetone;
a surfactant; and
a corrosion inhibitor.

2. The non-foaming pest control composition of claim 1, wherein the active agent is at least one of prallethrin, cypermethrin, and combinations thereof, the petroleum distillate is between about 2 wt. % and about 5 wt. %, the surfactant is between about 0.01 wt. % and about 0.1 wt. %, the corrosion inhibitor is between about 0.05 wt. % and about 0.4 wt. % of at least one of ammonium benzoate, sodium benzoate, anhydrous disodium phosphate, potassium dihydrogen phosphate, sodium nitrite, and combinations thereof, and wherein all weight percentages are percent by weight of the total composition.

3. The non-foaming pest control composition of claim 1, wherein the petroleum distillate is at least one of low odor paraffinic solvent, dearomatized kerosine, deodorized kerosene, and combinations thereof.

4. The non-foaming pest control composition of claim 1, wherein the surfactant is at least one of lecithin, Quillaja saponin, polyglyceryl oleate, glyceryl monooleate, sorbitan monooleate, and any combinations thereof.

5. The non-foaming pest control composition of claim 1, wherein the active agent is between about 0.02 wt. % and about 0.2 wt. %.

6. The non-foaming pest control composition of claim 1, wherein the at least one of ethyl alcohol, isopropyl alcohol, and acetone is between about 3 wt. % and about 15 wt. %.

7. The non-foaming pest control composition of claim 1 further comprising between 80 wt. % and 90 wt. % of water.

8. The non-foaming pest control composition of claim 1 further comprising at least one propellant.

9. The non-foaming pest control composition of claim 8, wherein the at least one propellant is about 1 wt. % to about 5 wt. %, based on the total weight of the composition.

10. The non-foaming pest control composition of claim 9, wherein the at least one propellant is nitrogen, liquified petroleum gas, butane, n-butane, isobutane, pentane, propane, or any combinations thereof.

11. A non-foaming pest control composition, comprising:
an active agent;
at least one of ethyl alcohol, isopropyl alcohol, and acetone;
sorbitan monooleate; and
sodium nitrite.

12. The non-foaming pest control composition of claim 11, wherein the active agent is at least one of prallethrin, cypermethrin, and combinations thereof, the sorbitan monooleate is between about 0.01 wt. % and about 0.5 wt. %, the corrosion inhibitor is between about 0.05 wt. % and about 0.4 wt. % of at least one of ammonium benzoate, sodium benzoate, anhydrous disodium phosphate, potassium dihydrogen phosphate, sodium nitrite, and combinations thereof, and wherein all weight percentages are percent by weight of the total composition.

13. The non-foaming pest control composition of claim 11, wherein the active agent is at least one of prallethrin, cypermethrin, and combinations thereof, the at least one of ethyl alcohol, isopropyl alcohol, and acetone is ethyl alcohol, the sorbitan monooleate is between about 0.01 wt. % and about 0.5 wt. %, the corrosion inhibitor is between about 0.05 wt. % and about 0.4 wt. % of either sodium nitrite or a combination of anhydrous disodium phosphate and potassium dihydrogen phosphate, and wherein all weight percentages are percent by weight of the total composition.

14. The non-foaming pest control composition of claim 11, wherein the active agent is between about 0.01 wt. % and about 0.2 wt. %.

15. The non-foaming pest control composition of claim 11 further comprising at least one propellant.

16. The non-foaming pest control composition of claim 15, wherein the at least one propellant is about 2 wt. % to about 4 wt. %, based on the total weight of the composition.

17. The non-foaming pest control composition of claim 16, wherein the at least one propellant is nitrogen, liquified petroleum gas, butane, n-butane, isobutane, pentane, propane, or any combinations thereof.

18. The non-foaming pest control composition of claim 11 further comprising between about 80 wt. % and about 90 wt. % of water.

19. A method of killing wasps or hornets comprising applying to the wasp or hornet a composition comprising an insecticide active agent, a petroleum distillate, a surfactant, a corrosion inhibitor, and at least one of ethyl alcohol, isopropyl alcohol, and acetone.

20. The method of claim 19, wherein the insecticide active agent is between about 0.02 wt. % and about 0.07 wt. %, the petroleum distillate is between about 2 wt. % and about 5 wt. %, the surfactant is between about 0.01 wt. % and about 0.1 wt. % of any one of polyglyceryl oleate, glyceryl monooleate, sorbitan monooleate, and any combinations thereof, and the corrosion inhibitor is between about 0.05 wt. % and about 0.26 wt. % of sodium nitrite, wherein all weight percentages are percent by weight of the total composition.
